(19) United States
(12) Patent Application Publication
(10) Pub. No.: US 2016/0099997 A1
(43) Pub. Date: Apr. 7, 2016

(54) METHOD AND SYSTEM FOR MANAGING APPLICATION DATA IN A COMMUNICATION DEVICE

(71) Applicant: Samsung Electronics Co., Ltd., Suwon-si (KR)

(72) Inventors: Arijit SEN, Bangalore (IN); Danish Ehsan HASHMI, Bangalore (IN); Prakash RAO, Bangalore (IN); Ratnakar Rao VENKATARAYAVARAPU, Bengaluru (IN)

(21) Appl. No.: 14/863,848

(22) Filed: Sep. 24, 2015

(30) Foreign Application Priority Data
Oct. 1, 2014 (IN) 4947/CHE/2014

(51) Int. Cl. H04L 29/08; H04L 29/06

(52) U.S. Cl. CPC H04L 67/04; H04L 67/42; H04L 67/16

(57) ABSTRACT

A method and a system for managing application data in a communication device when the application processor is in an inactive state are provided. The method includes identifying an application processor in an inactive state based on an event. In an embodiment of the present disclosure, the event can include detecting inactivity of a user. Further, the method includes communicating the application data with an application server by an agent in the communication device. In an embodiment of the present disclosure, uplink (UL) and downlink (DL) application data is transmitted and received to and from the application server respectively by the agent in the communication device. The application processor invokes the agent for managing the application data with the application server when the application processor is in the active state.

### CROSS-REFERENCE TO RELATED APPLICATION(S)

This application claims the benefit under 35 U.S.C. §119(a) of an Indian patent application filed on Oct. 1, 2014 in the Indian Patent Office and assigned Serial number 4947CHE/2014, the entire disclosure of which is hereby incorporated by reference.

### TECHNICAL FIELD

The present disclosure relates to managing application data in a communication device. More particularly, the present disclosure relates to a method and a system for managing application data in the communication device when an application processor is in an active or inactive state.

### BACKGROUND

Modern communication device (for example, a mobile device or a smart phone) provide additional functionality other than telephony, contacts, games, and photos, and the like. (For example, an Internet web browser, an email, and location based services, and the like). In general, an application processor of a communication device provides notifications of frequently used applications to a user.

The application processor wakes up or enters an active state to provide the notifications of the frequently used applications to the user. When the application processor wakes up, the application processor boots up many resources which are needed to provide many other services, which results in higher power consumption. Additionally, the application processor itself consumes more power for providing notifications of the frequently used applications to the user. When the user of a communication device is not actively using the communication device, the application processor is not needed to be in the active state. The application processor may therefore be temporarily inactive to conserve power.

The frequently used applications are always running in the background although the user is not actively using the communication device. These applications may perform synchronization with a server (associated with each application) for obtaining any updates and presenting the updates to the user. Further, there can be “Keep Alive” messages which are transmitted periodically from the communication device to the server for maintaining an active session between an application and the server. When the user is not actively using the communication device, particularly at night times or at certain intervals of a day, the Keep Alive messages wakes up the application processor, which may lead to the increase in battery power consumption of the communication device. Further, few of the applications download data from server (for example movie download, video's, and the like) which causes application processor to handle every packet received from network. Hence, the applications may not allow application processor to enter inactive state which leads to increase in battery power consumption.

Therefore, a need exists for a method and a system for managing application data in a communication device when an application processor is in an inactive state.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and a system for managing application data in a communication device when an application processor is in an inactive state.

Another aspect of the present disclosure is to provide a method and a system for managing application data in a communication device when the application processor is in an active state.

Another aspect of the present disclosure is to provide a method and a system for communicating application data with an application server through an agent in the communication device without waking the application processor.

In accordance with an aspect of the present disclosure, a method of managing application data in a communication device is provided. The method includes identifying an application processor in an inactive state based on an event and communicating the application data with at least one application server by an agent in the communication device.

In accordance with another aspect of the present disclosure, a method of managing application data in a communication device when an application processor is in an active state is provided. The method includes communicating the application data with at least one application server by an agent in the communication device.

In accordance with another aspect of the present disclosure, an electronic device for managing application data is provided. The electronic device includes an application processor, an agent along with an integrated circuit, at least one processor, and at least one memory. The memory comprises a computer program code within the integrated circuit. The computer program code is stored in the memory of the integrated circuit. Further, at least one processor in the integrated circuit executes the computer program code. The computer program code, when executed causes the electronic device to identify the application processor in an inactive state based on an event. Further, the electronic device is configured to communicate the application data with at least one application server by the agent.

In accordance with another aspect of the present disclosure, an electronic device for managing application data when an application processor is in an active state is provided. The electronic device includes the application processor, an agent along with an integrated circuit. Further the integrated circuit comprises at least one processor and at least one memory. The memory comprises a computer program code within the integrated circuit. The computer program code is stored in the memory of the integrated circuit. Further, at least one processor in the integrated circuit executes the computer program code. The computer program code, when executed causes the electronic device to communicate the application data with at least one application server by the agent.

In accordance with another aspect of the present disclosure, a computer program product is provided. The computer program product includes computer executable program code recorded on a computer readable non-transitory storage medium, the computer executable program code when executed causing the actions including identifying an application processor in an inactive state based on an event. The computer program code when executed causing the actions including communicating application data with at least one application server by an agent in a communication device.

In accordance with another aspect of the present disclosure, a computer program product is provided. The computer program product includes computer executable program code recorded on a computer readable non-transitory storage medium, the computer executable program code when executed causing the actions including communicating application data with at least one application server by an agent in a communication device, when an application processor is in an active state.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIGS. 1A, 1B, and 1C illustrate a system which includes an agent in a communication device for communicating application data with an application server according to various embodiments of the present disclosure;

FIG. 2 illustrates an application router communicating application data to an agent in a communication device according to various embodiments of the present disclosure;

FIG. 3A is a flow diagram illustrating a method for managing application data in a communication device according to various embodiments of the present disclosure;

FIG. 3B is a flow diagram illustrating a method for managing application data in a communication device when an application processor is in an active state according to various embodiments of the present disclosure;

FIG. 4A is a flow diagram illustrating various messages for communicating application data with an application server according to various embodiments of the present disclosure;

FIG. 4B is a flow diagram illustrating various messages for communicating application data with an application server when an application processor is in an active state according to various embodiments of the present disclosure;

FIG. 5 is a flow diagram illustrating various messages in which an application processor invokes an agent for communicating application data according to various embodiments of the present disclosure;

FIG. 6 is a flow diagram illustrating various operations in which an agent retrieves downlink (DL) application data and transmits the DL application data to an application processor according to various embodiments of the present disclosure;

FIG. 7 is a flow diagram illustrating various operations in which an agent transmits uplink (UL) application data to an application server according to various embodiments of the present disclosure;

FIG. 8 illustrates application data of a wearable device being communicated to an application server through an agent in a communication device according to various embodiments of the present disclosure; and

FIG. 9 illustrates a computing environment implementing a method and a system of managing application data in a communication device according to various embodiments of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

In embodiments of the present disclosure, the term “communication device” and the term “electronic device” are used interchangeably. The term “or” as used herein, refers to a non-exclusive or, unless otherwise indicated. The examples used herein are intended merely to facilitate an understanding of ways in which the various embodiments herein can be practiced and to further enable those skilled in the art to practice the various embodiments herein. Accordingly, the examples should not be construed as limiting the scope of the various embodiments herein.

The various embodiments herein achieve a method and a system of managing application data in a communication device when an application processor is in an inactive state. The method includes identifying the application processor in the inactive state based on an event.

The event includes all actions (for example, inputting of information, generating of information, executing of a function, outputting of information, and changing of a state) that may occur on a communication device, and may be classified according to an occurrence of one or more operations. An event may include any form of user interaction with the device.

In an embodiment of the present disclosure, the event may include but not limited to detecting whether back-light of the communication device is off, through sensors, a user interaction, and the like.

In an embodiment of the present disclosure, the communication device can be an electronic device, a mobile phone, a personal digital assistant (PDA), a smart phone, a tablet, a personal computer, a portable device, and the like.

Further, the method includes communicating the application data with an application server by an agent in the communication device. In an embodiment of the present disclosure, uplink (UL) application data is transmitted to the application server by the agent in the communication device. In an embodiment of the present disclosure, downlink (DL) application data is received from the application server by the agent in the communication device. The application processor invokes the agent for communicating the application data to the application server before entering into the inactive state.

When the application processor is in the active state, the method includes transmitting the DL application data to the application processor by the agent. The application processor enters the active state upon identifying an input from the user or due to an incoming call. In an embodiment of the present disclosure, when the user wishes to make a call or to access any notifications on the communication device, or if the user has any incoming call, the application processor enters into the active state from the inactive state. The application processor receives the DL application data from the agent and the DL application data will be presented to the user by the application processor.

Further, the various embodiments herein achieve a method and a system of managing application data in a communication device when the application processor is in the active state. The method includes communicating the DL and UL application data with the application server by the agent. The application processor invokes the agent to communicate the UL and DL application data with the application server. The application processor invokes the agent by transmitting a request message to the agent upon an indication from any of the active application clients for example, in cases of downloading or uploading files.

In an embodiment of the present disclosure, the agent transmits the UL application data to the application server on behalf of the application processor based on the one or more parameters which can be preconfigured by the application processor.

In an embodiment of the present disclosure, the one or more parameters may include but not limited to time interval and volume of UL application data.

Further, the agent transmits the DL application data to the application processor based on one or more parameters. The agent transmits the DL application data to the application processor based on the one or more parameters which can be preconfigured by the application processor. In an embodiment of the present disclosure, the one or more parameters may include but not limited to time interval and volume of the DL application data.

Unlike the system of the related art, the proposed method and system reduces the battery power consumption of the communication device by keeping the application processor in the inactive state. The agent in the communication device transmits the UL application data to the application server and receives the DL application data from the application server on behalf of the application processor which reduces the battery power consumption of the communication device. The proposed method and system discloses a mechanism for managing the application data using the agent without waking the application processor from the inactive state. Further, the proposed method and system manages the application data to and from the application server when the user is not interacting with the communication device.

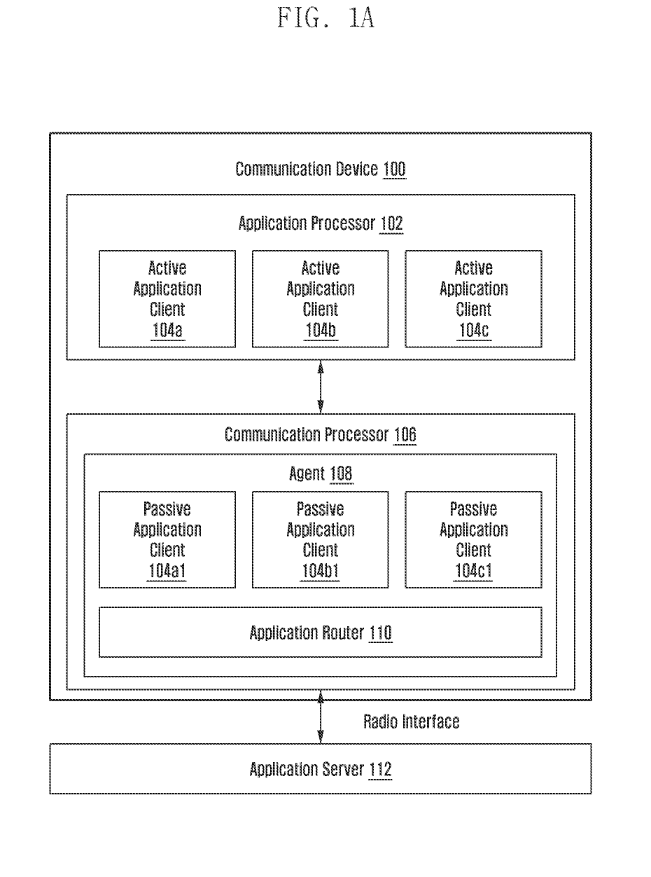

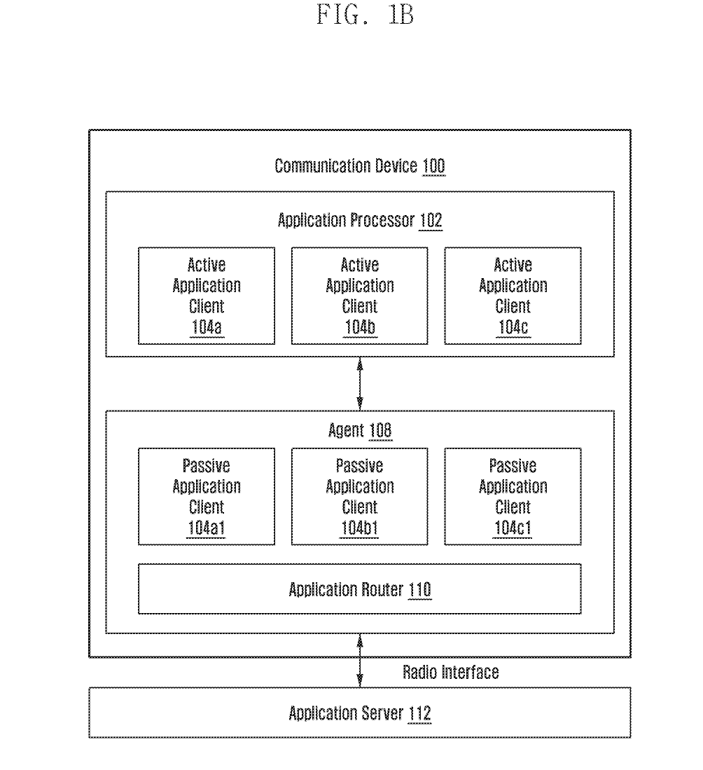

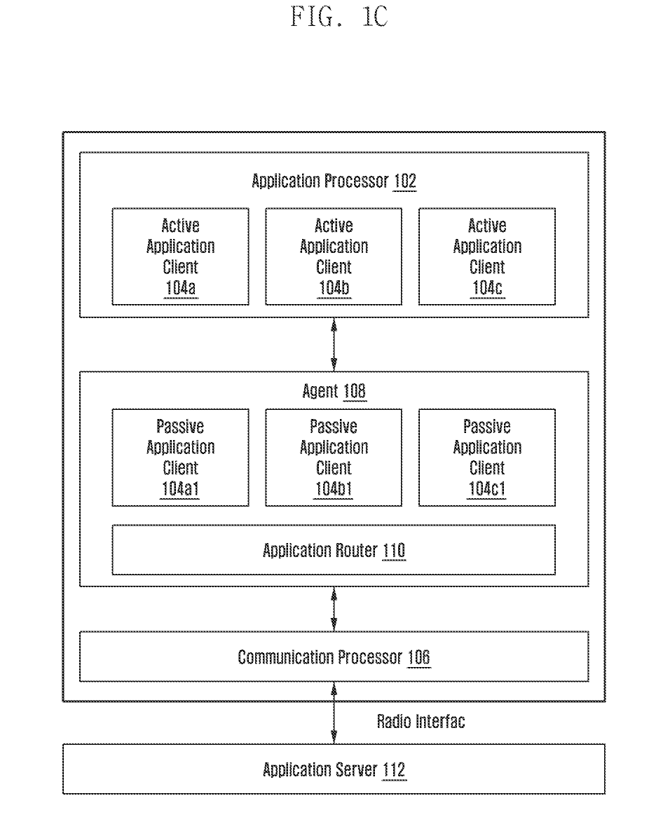

Referring now to the drawings and more particularly to FIGS. 1A through 9 where similar reference characters denote corresponding features consistently throughout the figures, there are shown preferred embodiments of the present disclosure.

FIGS. 1A, 1B, and 1C illustrate a system which includes an agent in a communication device for communicating application data with an application server according to various embodiments of the present disclosure.

Referring to FIGS. 1A, 1B, and 1C, a communication device 100 includes an application processor 102, a plurality of active application clients 104a, 104b, and 104c, a communication processor 106, an agent 108, an application router 110 and an application server 112. In an embodiment of the present disclosure, the agent 108 includes a plurality of passive application clients but not limited to 104a, 104b, and 104c as shown in FIG. 1A. The passive application clients 104a1, 104b1, and 104c1 correspond to the plurality of active application clients 104a, 104b, and 104c respectively running in the application processor 102. In an embodiment of the present disclosure, the application data corresponds to the plurality of the active application clients 104a, 104b, and 104c running in the application processor 102.

In an embodiment of the present disclosure, the agent 108 can be present within the communication processor 106 as depicted in FIG. 1A. In an embodiment of the present disclosure, the agent 108 can be present within a Bluetooth chip or a Wi-Fi chip, even though it is not shown in FIG. 1A.

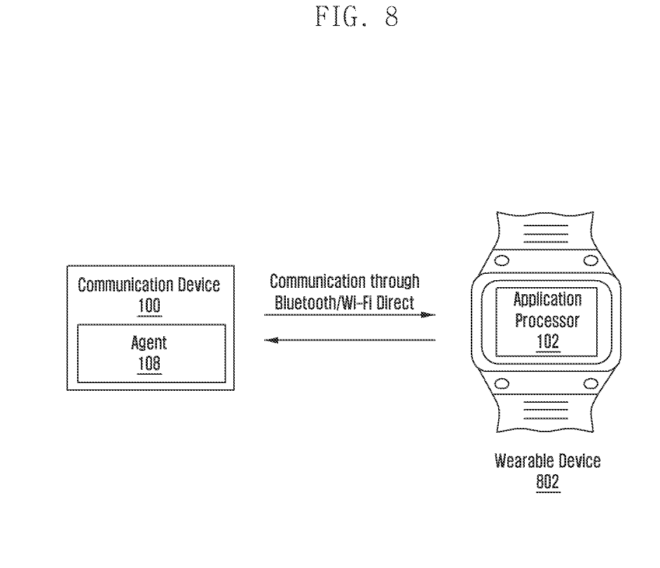

In an embodiment of the present disclosure, the agent 108 can be present within a processor of another communication device (for example, a wearable device). The agent 108 residing in another communication device (for example, a smart watch) is described in conjunction with FIG. 8.

The application data is communicated to the application server 112 through the agent 108 when the application processor 102 is in the inactive state. The application processor 102 enters into the inactive state is identified based on the event. In an embodiment of the present disclosure, when there is no user interaction in the communication device 100 during certain time intervals of a day (particularly the user may not be interacting with his/her communication device 100 at nights), in such cases the application processor 102 detects the user is not interacting with the communication device 100. In an embodiment of the present disclosure, the application processor 102 enters the inactive state based on an event, which can be detected by the application processor 102 using the existing methods which may include but not limited to device back-light off and other sensors or user inputs, and the like.

When the application processor 102 detects the event, the application processor 102 invokes the agent 108 in the communication processor 106 for communicating the application data to the application server 112. In an embodiment of the present disclosure, the application processor invokes the agent 108 in the communication processor 106 by transmitting a request message to the agent 108. The request message from the application processor 102 indicates the agent 108 that the application processor is entering into the inactive state.

The agent 108 receives the request message from the application processor 102 and starts communicating the application data both in UL and DL directions. The agent 108 communicates the application data to the application server 112 on behalf of the application processor 102. In an embodiment of the present disclosure, the agent 108 can independently communicate UL and DL application data with the application server 112, without the active application client's (104a, 104b, and 104c) running in the application processor 102. The agent 108 communicates the application data to the application server 112 till the application processor 102 enters the active state. In an embodiment of the present disclosure, the application processor enters the active state when the application processor 102 detects an input from the user or when the user has an incoming call. In an embodiment of the present disclosure, when the user wishes to make a call from his/her communication device 100 or when the user wants to access frequently used applications or notifications. When the application processor 102 enters the active state, the application processor 102 receives the DL application data from the agent which is stored in memory (as a buffer) of the agent 108. The DL application data which is received from the agent 108 is presented to the user by the application processor. FIGS. 1A through 1C are explained with an example as below.

In general, the user may not be interacting with his/her communication device 100 during certain time intervals of a day or especially during nights. The application processor 102 detects that the user is not interacting with the communication device 100 based on the event which may include detecting the device back-light off, sensors, a user input, and the like.

When the user is not interacting with the communication device 100, the application processor 102 enters into the inactive state. The application processor 102 transmits the request message to the agent 108 in the communication device 100. The request message indicates that the application processor 102 is entering into the inactive state. When the agent 108 receives the request message from the application processor 102, the agent 108 communicates the UL and the DL application data to and from the application server 112 on behalf of the application processor 102. The user may wish to download content to his communication device 100, in such cases, the user selects an application for downloading the content and the user may not interact with the communication device 100 after keeping the application active for downloading the content. When the application processor 102 detects that the user is not interacting with the communication device 100, the application processor 102 invokes the agent 108 in the communication device 100 for managing the download of the content. The agent 108 retrieves the content from the application server 102 and stores the content in a buffer. Thus, the agent 108 downloads the content on behalf of the application processor 102 till the application processor 102 is in the inactive state. In an embodiment of the present disclosure, the passive application clients 104a1, 104b1, and 104c1 receive the application data from the application router 110 and store the application data in the buffer at the agent 108. When the application processor 102 enters the active state, the passive application clients 104a1, 104b1, and 104c1 transmit the application data (Internet protocol (IP) data packets) to the corresponding active application clients 104a, 104b, and 104c running in the application processor 102.

When the application processor 102 enters the active state, upon receiving the input from the user or through the incoming call, the agent 108 transmits the downloaded content to the application processor 102 and the application processor 102 presents the downloaded content to the user.

In an embodiment of the present disclosure, the agent 108 can be present in between the application processor 102 and the application server 112 as shown in FIG. 1B. The agent 108 communicates with the application server through a radio interface. The application router 110 receives the DL application data from the application data from the application server 112 and routes the DL application data to each of the passive application clients in the agent 108 using the port number of each application. In an embodiment of the present disclosure, the agent 108 transmits the “Keep Alive” messages (which are transmitted from the communication device 100 to the application server 112 periodically for maintaining connection state between each application and the application server 112) to the application server 112 on behalf of the application processor 102 and thus reduces the battery power consumption of the communication device 100.

In an embodiment of the present disclosure, the agent 108 can be present in between the application processor 102 and the communication processor 106 as shown in FIG. 1C for managing the application data.

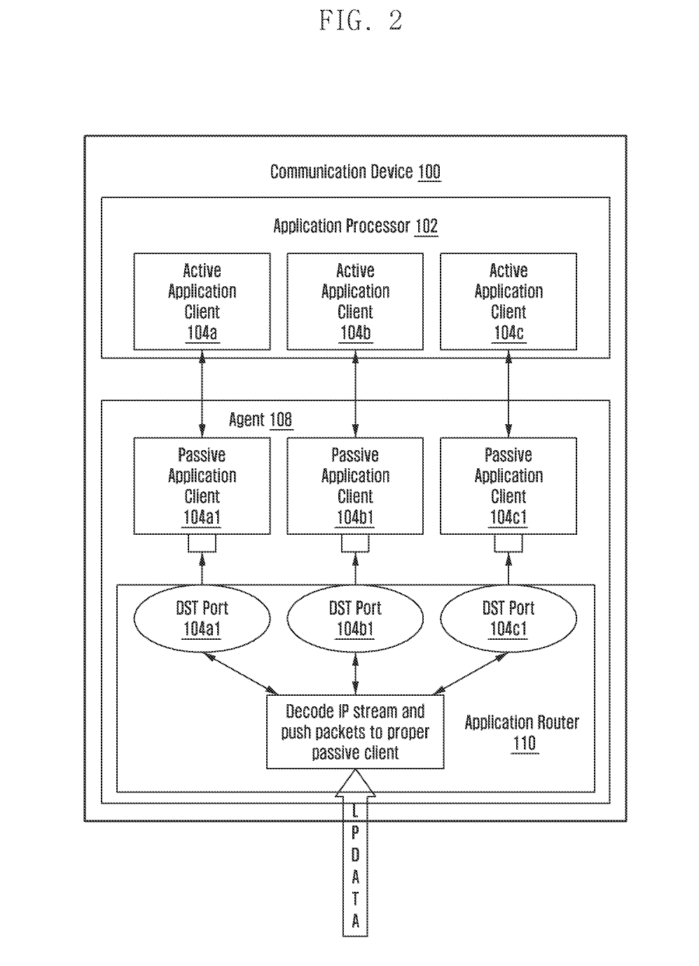

FIG. 2 illustrates an application router communicating application data to an agent in a communication device according to various embodiments of the present disclosure.

Referring to FIG. 2, the application router 110 receives the application data (IP data packets) from the application server 112. The application router 110 decodes the IP data packets and pushes the packets to the corresponding passive application clients (104a1, 104b1, and 104c1) using the port number of each application. The passive application clients receive the IP data packets from the application router 110 and store the IP data packets in a buffer memory of the agent 108. When the application processor 102 enters the active state, the passive application clients 104a1, 104b1, and 104c1 transmit the application data (IP data packets) to the corresponding active application clients 104a, 104b, and 104c as shown in FIG. 2. In an embodiment of the present disclosure, the agent 108 receives the DL application data from the application server 112 and analyzes the received DL application data. If the agent 108 determines that the received DL application data is important and is needed to the user, the agent 108 transmits the DL application data to the application processor 102 immediately for processing the received DL application data. The application processor, on receiving the DL application data may generate an alert for notifying the user regarding the application data received from the agent 108. Thus, the agent 108 can be provided with a functionality of analyzing and interpreting the DL application data without waking the application processor 102 from the inactive state.

In a similar manner, the passive application clients (104a1, 104b1, and 104c1) receive the UL application data (IP data packets) from the active application clients 104a, 104b, and 104c respectively and transmit the UL application data (IP data packets) to the application router 110 for transmitting the UL application data packets to the application server 112.

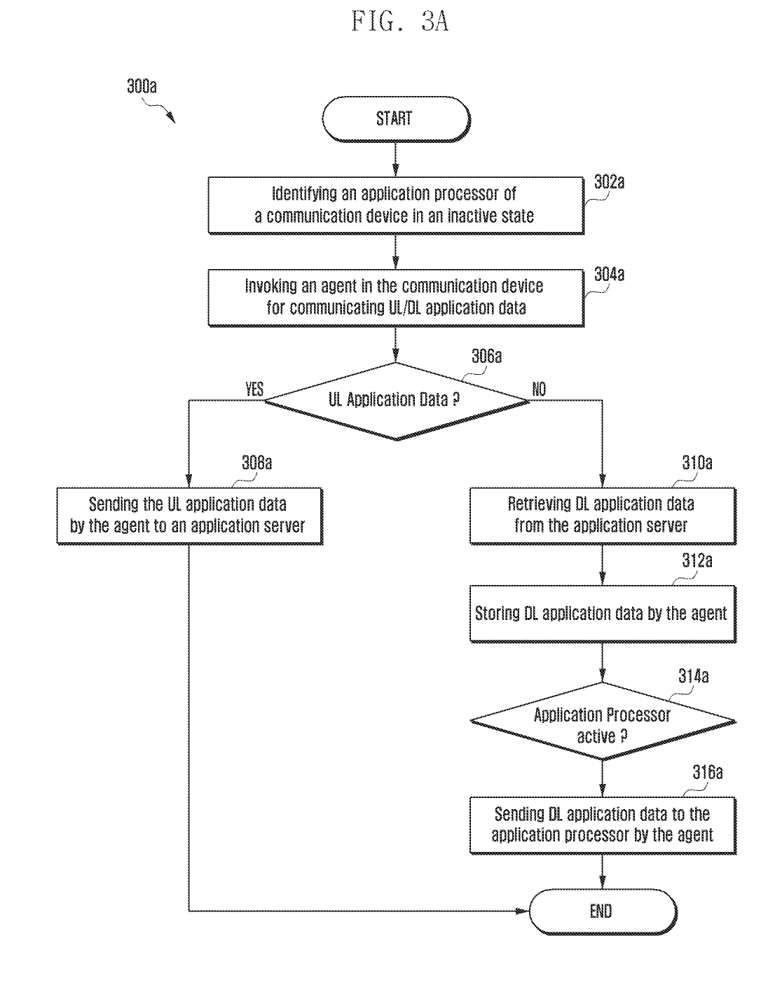

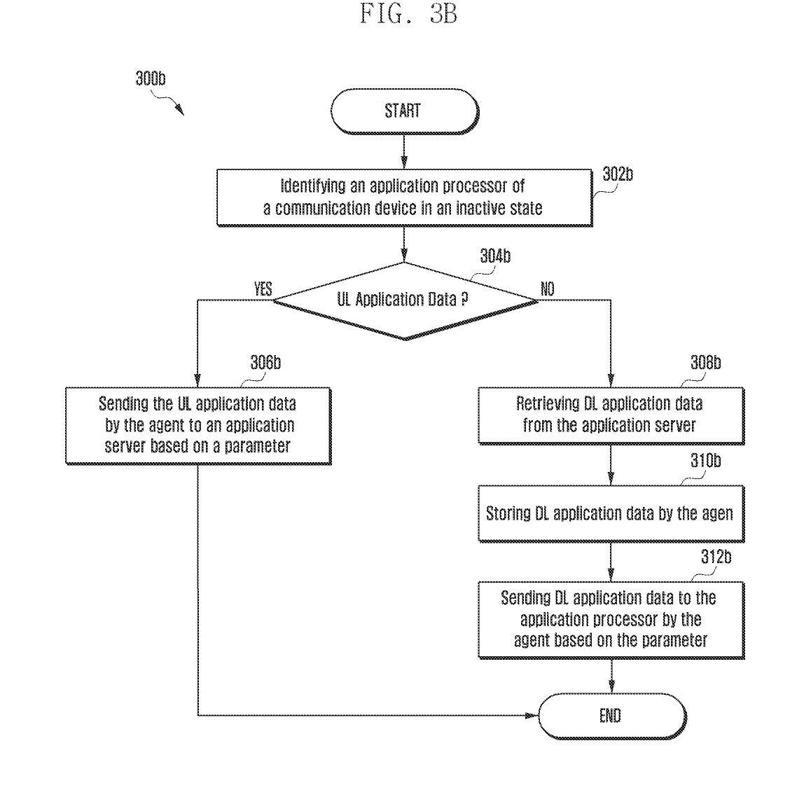

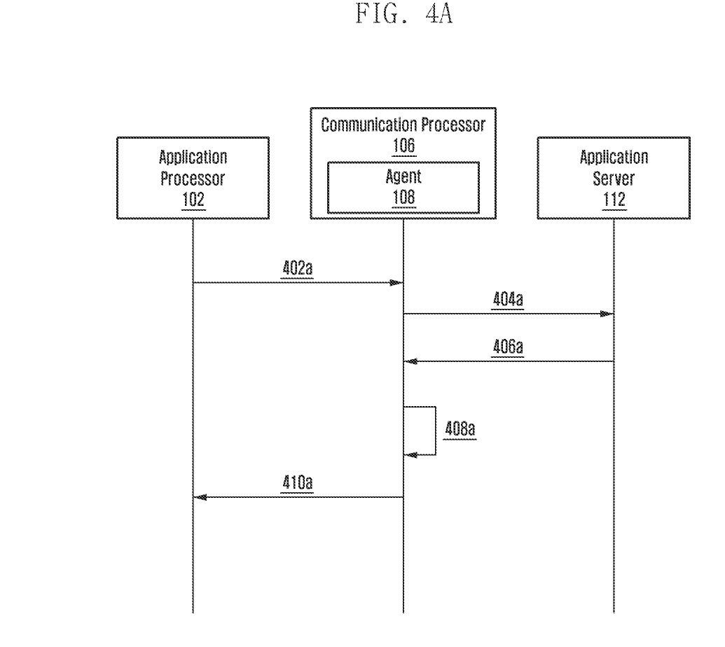

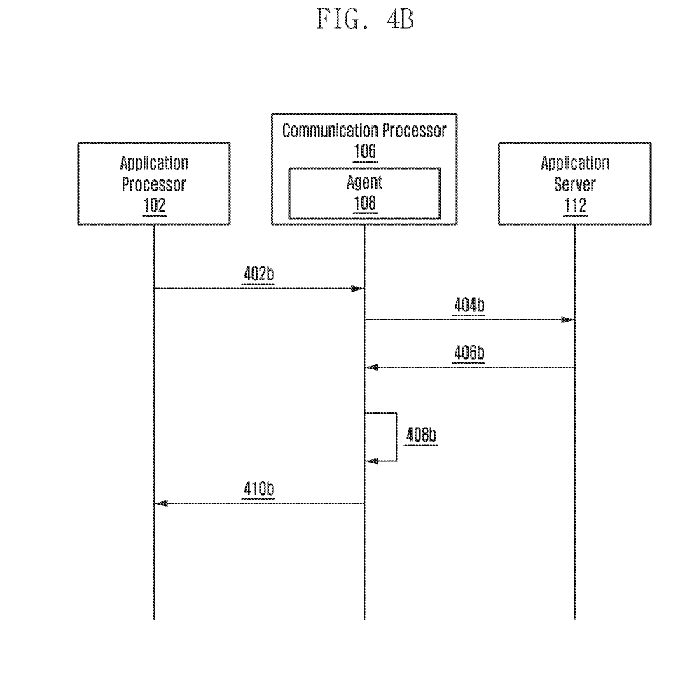

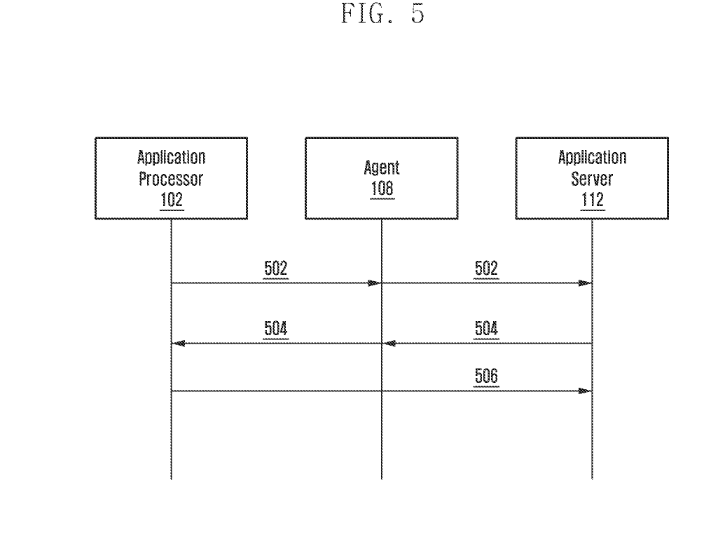

FIG. 3A is a flow diagram illustrating a method for managing application data in a communication device according to various embodiments of the present disclosure.

Referring to FIG. 3A, at operation 302a, a method 300a identifying the application processor 102 of the communication device 100 in the inactive state. The application processor 102 is identified in the inactive state based on the event which can be detected using the existing methods which may include but not limited to detecting the device back-light off, using any sensors and user inputs, and the like. When the application processor 102 is identified in the inactive state.

At operation 304a, the method 300a includes invoking the agent 108 in the communication device 100 for communicating the UL and the DL application data. The application processor 102 transmits the request message for invoking the agent 108. The request message indicates the agent 108 that the application processor 102 is entering the inactive state.

At operation 306a, the method 300a includes determining whether there exists the UL application data to the application server 112. The method 300a allows the agent 108 to determine whether there exists the application data from the application processor in UL direction.

If it is determined at operation 306a, that there exists the UL application data from the application processor 102, at operation 308a, the method 300a includes transmitting the UL application data by the agent 108 to the application server 112. The method 300a allows the agent 108 to transmit the UL application data to the application server 112 on behalf of the application processor 102.

If it is determined at operation 306a that there exists DL application data, at operation 310a, the method 300a includes retrieving DL application data from the application server 112. The method 300a allows the agent 108 to retrieve the DL application data from the application server 112.

At operation 312a, the method 300a includes storing DL application data by the agent 108. The method 300a allows the agent 108 to store the DL application data retrieved from the application server 112. In an embodiment of the present disclosure, the DL application data is stored in the buffer at the agent 108.

At operation 314a, the method 300a includes determining whether the application processor 102 of the communication device 100 is active. The application processor 102 enters the active state, when the user starts interacting with the communication device 100. In an embodiment of the present disclosure, the application processor 102 wakes up or enters the active state when the user wishes to make a call from his/her communication device 100 or the user wants to access frequently used applications, or notifications, and the like.

When the application processor 102 enters the active state, in an embodiment of the present disclosure, at operation 316a, the method 300a includes transmitting DL application data to the application processor 102 by the agent 108. The method 300a allows the agent 108 to transmit the DL application data to the application processor 102.

If it is determined at operation 314a that the application processor 102 is in the inactive state, in an embodiment of the present disclosure, the method 300a loops back to the operation 308a for retrieving the DL application data from the application server 112.

Further, the various actions, units, operations, blocks, or acts described in the method 300a can be performed in the order presented, in a different order, simultaneously, or a combination thereof. Furthermore, in some embodiments of the present disclosure, some of the actions, units, operations, blocks, or acts listed in FIG. 3A may be omitted.

FIG. 3B is a flow diagram illustrating a method for managing application data in a communication device when an application processor is in an active state according to various embodiments of the present disclosure.

Referring to FIG. 3B, when the application processor is in the active state, at operation 302b, the method 300b includes invoking the agent 108 in the communication device 100 for communicating the UL and the DL application data. The application processor 102 transmits the request message for invoking the agent 108.

At operation 304b, the method 300b includes determining whether there exists the UL application data to the application server 112. The method 300b allows the agent 108 to determine whether there exist the application data from the application processor in UL direction.

If it is determined at operation 304b, that there exists the UL application data from the application processor 102, at operation 306b, the method 300b includes transmitting the UL application data by the agent 108 to the application server 112 based on one or more parameters. The method 300b allows the agent 108 to transmit the UL application data to the application server 112 on behalf of the application processor 102 based on the one or more parameters which can be preconfigured by the application processor 102.

In an embodiment of the present disclosure, the one or more parameters may include but not limited to time interval and volume of UL application data.

In an embodiment of the present disclosure, the agent 108 transmits the UL application data to the application server 112 for every 5 minutes of time interval as preconfigured by the application processor. In another example, the agent 108 transmits the UL application data of size 100 MB to the application server 112. The agent 108 transmits the status of the UL application data (the volume of the uploaded data) to the application processor 102 and the application processor 102 displays the status bar corresponding to the UL application data uploaded to the application server 112.

If it is determined at operation 304b that there exists DL application data, at operation 308b, the method 300b includes retrieving the DL application data from the application server 112. The method 300b allows the agent 108 to retrieve the DL application data from the application server 112.

At operation 310b, the method 300b includes storing DL application data by the agent 108. The method 300b allows the agent 108 to store the DL application data retrieved from the application server 112. In an embodiment of the present disclosure, the DL application data is stored in the buffer at the agent 108.

At operation 312b, the method 300b includes transmitting the DL application data to the application processor 102 by the agent 108 based on the one or more parameters. The method 300b allows the agent 108 to transmit the DL application data to the application processor 102 based on the one or more parameters which can be preconfigured by the application processor 102.

In an embodiment of the present disclosure, the one or more parameters may include but not limited to time interval and volume of the DL application data. In an embodiment of the present disclosure, the agent transmits the DL application data to the application processor 102 at regular intervals of time, such as for every 10 minutes of time interval as preconfigured by the application processor 102. In another example, the agent 108 transmits the DL application data to the application processor for every 300 MB of downloaded data at the agent as preconfigured by the application processor 102. The agent 108 transmits the status of the DL application data (the volume of the downloaded application data) to the application processor 102 and the application processor 102 displays the status bar corresponding to the DL application data downloaded from the application server 112. In an embodiment of the present disclosure, when the agent 108 is communicating the UL and DL application data with the application server 112, the application processor 102 (in an active state) may perform or handle other actions, such as for example, executing gaming applications as requested by the user, displaying messages to the user and other related functionalities.

Further, the various actions, units, operations, blocks, or acts described in the method 300b can be performed in the order presented, in a different order, simultaneously, or a combination thereof. Furthermore, in some embodiments of the present disclosure, some of the actions, units, operations, blocks, or acts listed in FIG. 3B may be omitted.

FIG. 4A is a flow diagram illustrating various messages for communicating application data with an application server according to various embodiments of the present disclosure.

Referring to FIG. 4A, at operation 402a, the application processor 102 transmits the request message indicating that the application processor 102 is entering into the inactive state to the communication processor 106. The communication processor 106 receives the request message from the application processor 102. When the communication processor 106 receives the request message, the agent 108 starts communicating the application data to the application server 112 on behalf of the application processor 102 at operation 404a.

In an embodiment of the present disclosure, the agent 108 transmits the UL application data to the application server 112 through the radio interface. In an embodiment of the present disclosure, the agent 108 can independently communicate UL and DL application data to the application server 112.

When there is DL application data from the application server 112, the agent 108 retrieves the DL application data from the application server 112 at operation 406a.

At operation 408a, the agent 108 stores the DL application data from the application server 112 in the buffer at the agent 108. In an embodiment of the present disclosure, each passive application client in the agent 108 receives the corresponding to the application from the application server. In an embodiment of the present disclosure, the passive application client 104a1 receives the application data corresponding to the active application client running at the application processor 102.

When the application processor 102 enters the active state, which is determined based on user interaction with the communication device 100, or through an incoming call or any other event, the communication processor 106 transmits the DL application data to the application processor 102 at operation 410a.

FIG. 4B is a flow diagram illustrating various messages for communicating application data with an application server when an application processor is in an active state according to various embodiments of the present disclosure.

Referring to FIG. 4B, at operation 402b, the application processor 102 transmits the request message to the communication processor 106. In an embodiment of the present disclosure, the request message includes one or more parameters preconfigured in the communication processor 106 to transmit the UL data to the application server 112. The one or more parameters may include but not limited to time interval and volume of UL application data.

The communication processor 106 receives the request message from the application processor 102. The request message from the application processor 102 indicates the agent to initiate communication of the application data with the application server 112. When the communication processor 106 receives the request message, at operation 404b, the agent 108 starts communicating the application data with the application server 112 on behalf of the application processor 102.

The agent 108 transmits the UL application data to the application server 112 through the radio interface based on one or more parameters preconfigured by the application processor 102. In an embodiment of the present disclosure, the agent 108 can independently communicate the UL data and the DL application data to the application server 112. In an embodiment of the present disclosure, the agent 108 transmits the UL application data to the application server 112 on behalf of the application processor 102.

When there is DL application data from the application server 112, at operation 406b, the agent 108 retrieves the DL application data from the application server 112.

At operation 408b, the agent 108 stores the DL application data from the application server 112 in the buffer at the agent 108. In an embodiment of the present disclosure, each passive application client in the agent 108 receives the corresponding to the application from the application server. In an embodiment of the present disclosure, the passive application client 104a1 receives the application data corresponding to the active application client running at the application processor 102.

At operation 410b, the agent 108 transmits the DL application data to the application processor 102 based on the one or more parameters which can be preconfigured by the application processor 102. In an embodiment of the present disclosure, the one or more parameters may include but not limited to time interval and volume of the DL application data.

FIG. 5 is a flow diagram illustrating various messages in which an application processor invokes an agent for communicating application data according to various embodiments of the present disclosure.

Referring to FIG. 5, at operation 502, the application processor 102 transmits synchronization (SYN) message to the agent 108. The agent 108 receives the SYN message from the application processor 102 and, at operation 502, forwards the SYN message to the application server 112.

When the application server 112 receives the SYN message from the agent 108, the application server 112 transmits the acknowledgment (ACK) message along with the SYN message (SYN+ACK) to the agent 108. When the agent 108 receives the SYN+ACK message from the application server 112, the agent 108 allocates the buffer and the port number of the source along with the destination are stored at the agent 108 for identifying data stream (data flow) of the application data.

At operation 504, the agent 108 forwards the SYN+ACK message to the application processor 102. In an embodiment of the present disclosure, at operation 506, the application processor 102 transmits the ACK message to the application server 112.

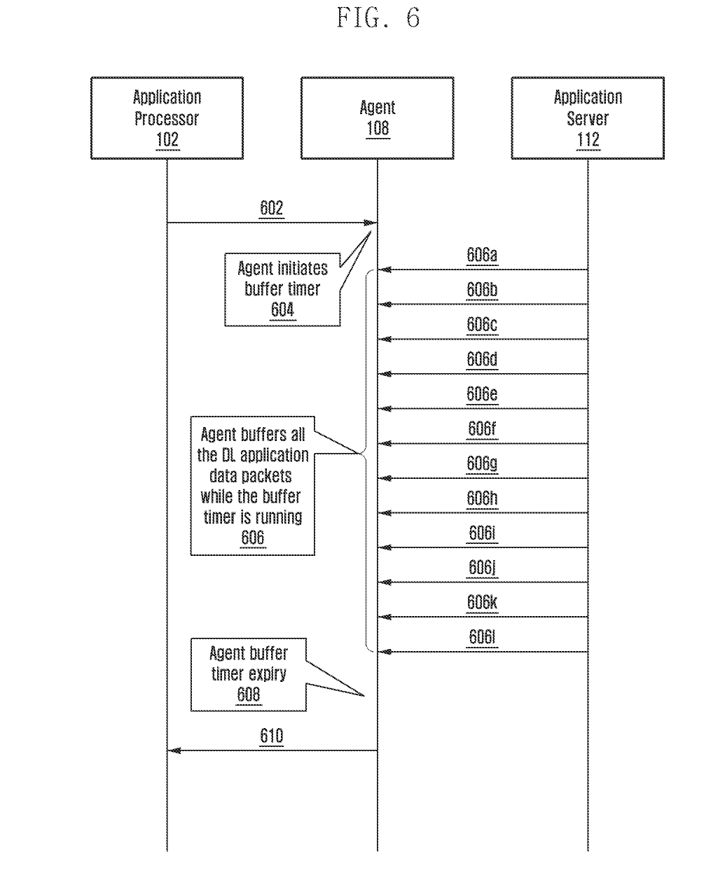

FIG. 6 is a flow diagram illustrating various operations in which an agent retrieves DL application data and transmits the DL application data to an application processor according to various embodiments of the present disclosure.

Referring to FIG. 6, at operation 602, the application processor 102 transmits the request message which indicates the agent 108 that the application processor 102 is entering the inactive state. The agent 108 receives the request message from the application processor 102 and in an embodiment of the present disclosure, the agent 108 initiates a buffer timer upon receiving the request message from the application processor 102 at operation 604. In an embodiment of the present disclosure, the buffer timer can be configurable.

The agent 108 retrieves the DL application data packets from the application server 112. Further, at operation 606, the agent 108 buffers the DL application data packets from the application server 112. In the sequence diagram shown in FIG. 6, the operations 606a, 606d, 606e, 606g, and 606k denote the DL application data packets for the passive application client 104a1 in the agent 108. The operations 606b, 606f, 606i, and 606l denote the DL application data packets for the passive application client 104b1 in the agent 108. The operations 606c, 606h, and 606j denote the DL application data packets for the passive application client 104c1 in the agent 108.

When the buffer timer, running at the agent 108 expires at operation 608, the agent 108 transmits the DL application data (606a, 606b, 606c, 606d, 606e, 606f, 606g, 606h, 606i, 606j, 606k, and 606l) which is buffered at the agent 108 to the corresponding active clients 104a, 104b, and 104c respectively which are running in the application processor 102, at operation 610.

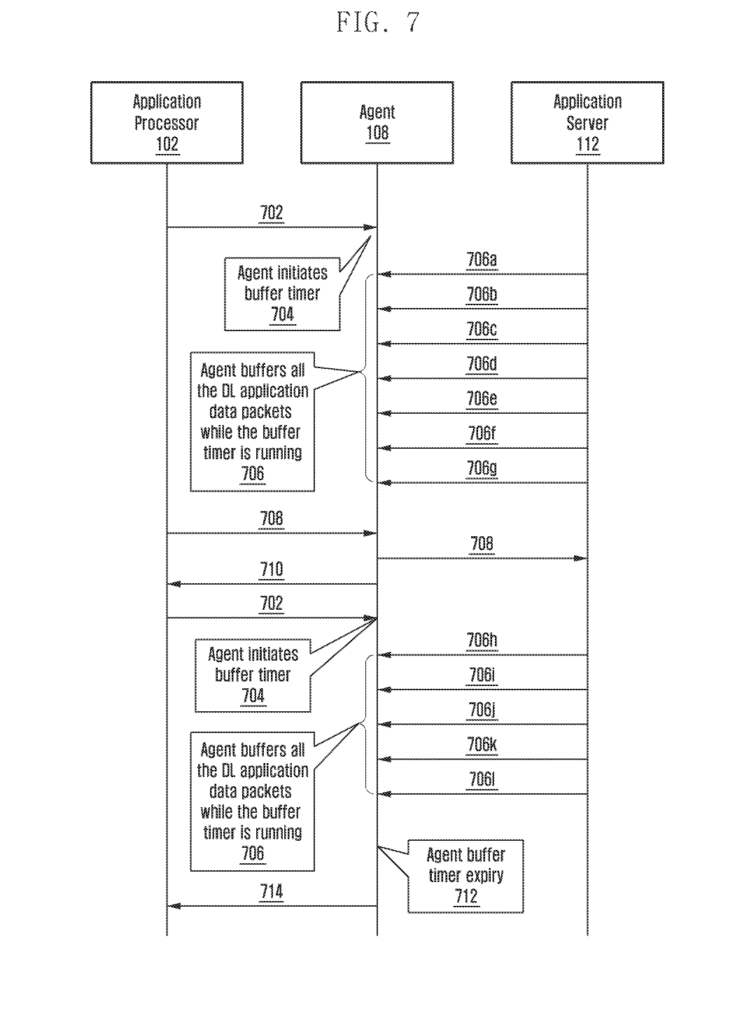

FIG. 7 is a flow diagram illustrating various operations in which an agent transmits UL application data to an application server according to various embodiments of the present disclosure.

Referring to FIG. 7, at operation 702, the application processor 102 transmits the request message which indicates the agent 108 that the application processor 102 is entering the inactive state. The agent 108 receives the request message from the application processor 102 and in an embodiment of the present disclosure, the agent 108 initiates the buffer timer upon receiving the request message from the application processor 102 at operation 704. The agent 108 retrieves all the DL application data packets from the application server 112.

At operation 706, the agent 108 buffers the DL application data packets from the application server 112. In the sequence diagram shown in FIG. 7, the operations 706a, 706d, 706e, and 706g denote the DL application data packets for the passive application client 104a1 in the agent 108. The operations 706b and 706f denote the DL application data packets for the passive application client 104b1 in the agent 108.

The operation 706c denotes the DL application data packet for the passive application client 104c1 in the agent 108. While the DL application data packets are being buffered at the agent 108, at operation 708, the application processor 102 transmits a UL application data packet received from the application client 104a to the agent 108. The application processor enters the active state for transmitting the UL application data packet to the agent 108. The agent 108 receives the UL application data packet from the application processor 102 and forwards the UL application data packet to the application server 112 at operation 708. At operation 710, the agent 108 transmits the buffered DL application data packets which includes 706a, 706b, 706c, 706d, 706e, 706f, and 707g to the corresponding active application clients 104a, 104b, and 104c respectively which are running in the application processor 102.

Further, the application processor 102 receives the DL application data packets from the agent 108 and enters the inactive state. In an embodiment of the present disclosure, at operation 702, the application processor 102 transmits the request message which indicates the agent 108 that the application processor 102 is entering the inactive state. The agent 108 receives the request message from the application processor 102 and in an embodiment of the present disclosure, the agent 108 initiates the buffer timer upon receiving the request message from the application processor 102 at operation 704.

The agent 108 retrieves all the DL application data packets from the application server 112. Further, at operation 706, the agent 108 buffers all the DL application data packets from the application server 112. In the sequence diagram, in FIG. 7, the operations 706h and 706k denote the DL application data packets for the passive application client 104a1 in the agent 108. The operations 706j and 706l denote the DL application data packets for the passive application client 104b1 in the agent 108. The operations 706i and 706k denote the DL application data packets for the passive application client 104c1 in the agent 108.

When the buffer timer, running at the agent 108 expires at operation 712, at operation 714, the agent 108 transmits the DL application data (706a, 706b, 706c, 706d, 706e, and 706f, which is buffered at the agent 108) to the corresponding active clients 104a, 104b, and 104c respectively, which are running in the application processor 102.

FIG. 8 illustrates application data of a wearable device being communicated to an application server through an agent in a communication device according to various embodiments of the present disclosure.

Referring to FIG. 8, when the application processor 102 of a wearable device 802 (for example, a watch as shown in FIG. 8) is in an active or inactive state, the application processor 102, invokes the agent 108 which is present in communication device 100 for communicating the application data with the application server 112. The application processor 102 transmits the request message to the agent 108 in the communication device 100 using Bluetooth, Wi-Fi direct, near field communication (NFC), and the like. The agent 108 receives the request message from the application processor 102 and communicates the application data to the application server 112.

In FIG. 8, the communication device 100 and the wearable device 802 communicates with each other through radio frequency communication means, such as but not limited to Bluetooth, Wi-Fi direct, NFC, and the like.

In an embodiment of the present disclosure, consider the scenario, where the application processor is in an inactive state and the application processor 102 transmits the request message to the agent 108 for communicating the application data. In such case, the agent 108 communicates the application data (both UL and DL application data) with the application server 112. In an embodiment of the present disclosure, the agent 108 transmits the UL application data to the application server 112 on behalf of the application processor 102 based on the one or more parameters which can be preconfigured by the application processor 102. The one or more parameters may include but not limited to time interval and volume of UL application data.

When the application processor 102 of the wearable device 802 enters the active state from the inactive state, the agent 108 identifies that the application processor of the wearable device 802 is active. The agent 108 transmits the DL application data to the application processor 102 through the radio frequency communication means, such as Bluetooth, Wi-Fi direct, NFC, and the like, and the application processor 102 presents the application data to the user.

In a similar manner, the agent 108 in the communication device 100 transmits the UL application data on behalf of the application processor in the wearable device 802 to the application server 112 based on one or more parameters as preconfigured by the application processor. Thus, the wearable device 802 can reduce battery power consumption, when the application processor 102 (in the wearable device 802) invokes the agent 108 in the communication device 100 for communicating the UL and DL application data with the application server 112.

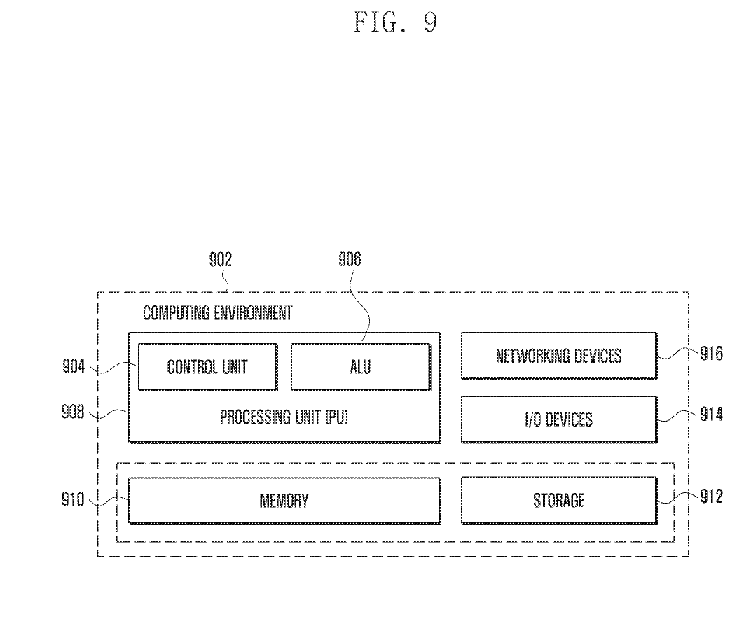

FIG. 9 illustrates a computing environment implementing a method and a system of managing application data in a communication device according to various embodiments of the present disclosure.

Referring to FIG. 9, a computing environment 902 comprises at least one processing unit 908 that is equipped with a control unit 904 and an arithmetic logic unit (ALU) 906, a memory 910, a storage unit 912, plurality of networking devices 916 and a plurality of input/output (I/O) devices 912. The memory 910 is shared with the at least one processing unit 908. The processing unit 908 is responsible for processing the instructions of the algorithm. The processing unit 908 receives commands from the control unit in order to perform its processing. Further, any logical and arithmetic operations involved in the execution of the instructions are computed with the help of the ALU 906.

The overall computing environment 902 can include multiple homogeneous and/or heterogeneous cores, multiple central processing units (CPUs) of different kinds, special media and other accelerators. The processing unit 908 is responsible for processing the instructions of the algorithm. Further, the plurality of processing units 908 may be located on a single chip or over multiple chips.

The algorithm comprising of instructions and codes required for the implementation are stored in either the memory unit 910 or the storage 912 or both. At the time of execution, the instructions may be fetched from the corresponding memory 905 and/or storage 912, and executed by the processing unit 904.

In case of any hardware implementations various networking devices 916 or external I/O devices 914 may be connected to the computing environment to support the implementation through the networking unit and the I/O device unit.

The various embodiments disclosed herein can be implemented through at least one software program running on at least one hardware device and performing network management functions to control the elements. The elements shown in FIGS. 1A, 1B, 1C, 2, 4A, 4B, 5, 6, 7, 8, and 9 include blocks which can be at least one of a hardware device, or a combination of hardware device and software module.

Certain aspects of the present disclosure can also be embodied as computer readable code on a non-transitory computer readable recording medium. A non-transitory computer readable recording medium is any data storage device that can store data which can be thereafter read by a computer system. Examples of the non-transitory computer readable recording medium include a Read-Only Memory (ROM), a Random-Access Memory (RAM), Compact Disc-ROMs (CD-ROMs), magnetic tapes, floppy disks, and optical data storage devices. The non-transitory computer readable recording medium can also be distributed over network coupled computer systems so that the computer readable code is stored and executed in a distributed fashion. In addition, functional programs, code, and code segments for accomplishing the present disclosure can be easily construed by programmers skilled in the art to which the present disclosure pertains.

At this point it should be noted that the various embodiments of the present disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the various embodiments of the present disclosure as described above. Alternatively, one or more processors operating in accordance with stored instructions may implement the functions associated with the various embodiments of the present disclosure as described above. If such is the case, it is within the scope of the present disclosure that such instructions may be stored on one or more non-transitory processor readable mediums. Examples of the processor readable mediums include a ROM, a RAM, CD-ROMs, magnetic tapes, floppy disks, and optical data storage devices. The processor readable mediums can also be distributed over network coupled computer systems so that the instructions are stored and executed in a distributed fashion. In addition, functional computer programs, instructions, and instruction segments for accomplishing the present disclosure can be easily construed by programmers skilled in the art to which the present disclosure pertains.

While the present disclosure has been shown and described with reference to various embodiments thereof, it will be understood by those skilled in the art that changes in form and details may be made therein without departing from the spirit and scope of the present disclosure as defined by the appended claims and their equivalents.

What is claimed is:

1. An electronic device for managing application data, the electronic device comprising:
an agent configured to:
identify an inactive state of an application processor, and
communicate the application data with at least one application server while the inactive state is maintained.

2. The electronic device of claim 1, wherein the agent comprises at least one passive application client associated with at least one active application client running in the application processor.

3. The electronic device of claim 1, wherein the application data corresponds to the at least one active application client running in the application processor.

4. The electronic device of claim 1, wherein the electronic device is configured to:
invoke the agent to communicate uplink application data with the at least one application server by the application processor, and
transmit the uplink application data by the agent with the at least one application server.

5. The electronic device of claim 1, wherein the electronic device is configured to:
invoke the agent to communicate downlink application data with the at least one application server by the application processor,
retrieve the downlink application data from the at least one application server by the agent, and
store the downlink application data from the at least one application server by the agent.

6. The electronic device of claim 1, wherein the electronic device is further configured to:
determine whether the application processor is in an active state, and
transmit by the agent the stored downlink application data to the application processor in response to determining that the application processor is in the active state.

7. An electronic device for managing application data when an application processor is in an active state, the electronic device comprising:
the application processor;
an agent;
an integrated circuit further comprising at least one processor; and
at least one memory having a computer program code within the integrated circuit,
wherein the at least one memory and the computer program code with the at least one processor cause the electronic device to communicate the application data with at least one application server by the agent.

8. The electronic device of claim 7, wherein the agent comprises at least one passive application client associated with at least one active application client running in the application processor.

9. The electronic device of claim 7, wherein the application data corresponds to the at least one active application client running in the application processor.

10. The electronic device of claim 7, wherein the device is configured to:
invoke the agent to communicate uplink application data with the at least one application server by the application processor, and
transmit the uplink application data by the agent with the at least one application server based on at least one parameter preconfigured by the application processor.

11. The electronic device of claim 7, wherein the electronic device is configured to:
invoke the agent to communicate downlink application data with the at least one application server by the application processor,
retrieve the downlink application data from the at least one application server by the agent,
store the downlink application data from the at least one application server by the agent, and
transmit the downlink application data to the application processor based on the at least one parameter preconfigured by the application processor.

12. The electronic device of claim 7, wherein the parameter comprises at least one time interval and at least one of volume of the uplink application data or volume of the downlink application data.

13. A method for managing application data, the method comprising:
identifying an application processor in an inactive state based on an event; and
communicating application data with at least one application server by an agent in a communication device.

14. The method of claim 13, wherein the agent comprises at least one passive application client associated with at least one application client running in the application processor.

15. The method of claim 13, wherein the application data corresponds to the at least one active application client running in the application processor.

16. The method of claim 13, further comprising:
invoking the agent to communicate uplink application data with the at least one application server by the application processor; and
transmitting the uplink application data by the agent with the at least one application server.

17. The method of claim 13, further comprising:
invoking the agent to communicate downlink application data with the at least one application server by the application processor;
retrieving the downlink application data from the at least one application server by the agent; and
storing the downlink application data from the at least one application server by the agent.

18. The method of claim 17, further comprising:
determining whether the application processor is in an active state; and
transmitting by the agent the downlink application data to the application processor in response to determining that the application processor is in the active state.
